(19) United States
(12) Patent Application Publication
(10) Pub. No.: US 2020/0412149 A1
(43) Pub. Date: Dec. 31, 2020

(54) EMERGENCY POWER SUPPLY CAPABLE OF OUTPUTTING MULTIPLE VOLTAGES AND CONTROL METHOD THEREOF

(71) Applicant: Shenzhen Chifrog Technology Co., Ltd., Shenzhen (CN)

(72) Inventors: Fang LI, Shenzhen (CN); Yunzheng JIANG, Shenzhen (CN)

(73) Assignee: Shenzhen Chifrog Technology Co., Ltd., Shenzhen (CN)

(21) Appl. No.: 16/557,231

(22) Filed: Aug. 30, 2019

(30) Foreign Application Priority Data
Jun. 28, 2019 (CN) 201910576588.8

(51) Int. Cl. H02J 7/00

(52) U.S. Cl. CPC H02J 7/0063

(57) ABSTRACT

An emergency power supply capable of outputting multiple voltages and a control method thereof. In the emergency power supply, power supply assemblies are used for outputting a specific voltage value, and two ends of each power supply assembly are respectively electrically connected with an output of the emergency power supply directly or indirectly using a switch assembly so that different power supply assemblies are connected in series or in parallel and different voltage values can be outputted by the output of the emergency power supply.

### CROSS-REFERENCE TO RELATED APPLICATIONS

This application is based upon and claims priority to Chinese Patent Application No. 201910576588.8, filed Jun. 28, 2019, the entire contents of which are incorporated herein by reference.

### TECHNICAL FIELD

The present invention relates to the field of electrical control and application, and more particularly, to an emergency power supply capable of outputting multiple voltages and a control method thereof.

### BACKGROUND

Current vehicles relying on engines to start and work, such as motorcycles, yachts, household cars and cargo trucks, need to be provided with built-in battery to start the engines. If the built-in battery fails, loses power, or is used in cold weather, the engine may not start as desired. Resulting in inconvenience for a user.

In view of this reliance and potential failure or loss battery performance, an emergency power supply can be used to replace the built-in battery to provide electric energy, so as to ensure the normal starting and use of the engines and the vehicles. However, known emergency power supplies are unable to be applied to various vehicles. For example, some cars require 12V emergency power supplies and some cars need 24V emergency power supplies; while known emergency power supplies can only provide electric energy for one type of cars. This requires users to provide different types of emergency power supplies for vehicles with different requirements, thus causing inconvenience for the users and increasing the use cost.

### SUMMARY

Exemplary embodiments of the present invention aim at providing an emergency power supply capable of outputting multiple voltages and a control method thereof, so that the emergency power supply can be suitable for vehicles with different voltage requirements.

Therefore, the present invention provides an emergency power supply capable of outputting multiple voltages, comprising two or more power supply assemblies, a switch assembly and a switch control circuit, wherein:

each power supply assembly is used for outputting a specific voltage value, and the two ends of each power supply assembly are respectively electrically connected directly or indirectly with an output of the emergency power supply;

the switch assembly comprises at least one electric control switch; the at least one electric control switch is connected in series between one power supply assembly and the output of the emergency power supply, and/or between different power supply assemblies;

an input of the switch control circuit receives a voltage switching signal; an output of the switch control circuit outputs a switch control signal corresponding to the voltage switching signal to a controlled end of each electric control switch; and each electric control switch is switched on or off under control of the switch control signal, so that the power supply assemblies are connected in series or in parallel, and thus different voltage values can be outputted by the output end of the emergency power supply.

Optionally, in an exemplary embodiment of an emergency power supply capable of outputting multiple voltages, the emergency power supply comprises two power supply assemblies, which are respectively, a first power supply assembly and a second power supply assembly; and the switch assembly comprises three electric control switches, which are respectively a first electric control switch, a second electric control switch, and a third electric control switch; wherein:

a first end of the first power supply assembly is electrically connected with a first end of the emergency power supply, and a second end of the first power supply assembly is connected with a first end of the first electric control switch;

a second end of the first electric control switch is connected with a first end of the second power supply assembly, and a second end of the second power supply assembly is connected with a second end of the emergency power supply;

a first end of the second electric control switch is connected with the first end of the first power supply assembly, and a second end of the second electric control switch is connected with the second end of the first electric control switch; and

a first end of the third electric control switch is connected with the second end of the first power supply assembly, and a second end of the third electric control switch is connected with the second end of the second power supply assembly.

In an exemplary embodiment of an emergency power supply capable of outputting multiple voltages, the first power supply assembly and the second power supply assembly each comprise a plurality of lithium iron phosphate batteries connected in series.

In an exemplary embodiment of an emergency power supply capable of outputting multiple voltages, each of the first power supply assembly and the second power supply assembly consists of two lithium batteries connected in series; or, each of the first power supply assembly and the second power supply assembly consists of three lithium iron phosphate batteries connected in series.

In an exemplary embodiment of an emergency power supply capable of outputting multiple voltages, the first electric control switch, the second electric control switch and the third electric control switch are all MOS transistors, a gate of each of the MOS transistors is used as the controlled end, and a source and a drain of each of the MOS transistors are used as the first end and the second end.

Optionally, in an exemplary embodiment of an emergency power supply capable of outputting multiple voltages, the switch control circuit comprises a controller; and

an input of the controller is used for receiving the voltage switching signal; a first output of the controller is electrically connected with the gate of the MOS transistor of the first electric control switch, a second output of the controller is electrically connected with the gate of the MOS transistor of the second electric control switch, and a third output of the controller is electrically connected with the gate of the MOS transistor of the third electric control switch.

Optionally, in an exemplary embodiment of an emergency power supply capable of outputting multiple voltages, when the voltage switching signal corresponds to a low voltage value, the controller outputs a switch control signal to switch off the first electric control switch but switch on the second electric control switch and the third electric control switch; and a voltage value outputted by the output of the emergency power supply is a voltage value produced by the first power supply assembly and the second power supply assembly connected in parallel; and

when the voltage switching signal corresponds to a high voltage value, the controller outputs a switch control signal to switch on the first electric control switch and switches off the second electric control switch and the third electric control switch; and a voltage value outputted by the output of the emergency power supply is a voltage value produced by the first power supply assembly and the second power supply assembly connected in series.

Optionally, in an exemplary embodiment of an emergency power supply capable of outputting multiple voltages further comprises a voltage sensor, wherein:

the voltage sensor is used for detecting a voltage value of a device to be connected and outputting a voltage signal representing the voltage value of the device to be connected, and if the voltage signal is within a normal voltage value range, the voltage signal is used as the voltage switching signal.

Optionally, the above emergency power supply capable of outputting multiple voltages further comprises a temperature sensor and a temperature regulating plate, wherein:

the temperature sensor is used for detecting a temperature of the emergency power supply and outputting a temperature signal representing the temperature of the emergency power supply to the switch control circuit;

after the temperature signal is received by the switch control circuit, if the temperature signal indicates that the temperature of the emergency power supply is lower than a lower limit threshold or higher than an upper limit threshold, a temperature regulating signal is outputted by the output of the switch control circuit; and

the temperature regulating plate is arranged in the power supply assembly, and the temperature regulating signal is received by a controlled end of the temperature regulating plate to raise or lower the temperature of the power supply assembly.

Exemplary embodiments further provide a method of controlling any one of the emergency power supplies capable of outputting multiple voltages, comprising the following steps of:

in response to a voltage switching signal, determining series/parallel connection relations between different power supply assemblies according to the voltage switching signal, and determining a state of each electric control switch according to the series/parallel connection relations;

obtaining a switch control signal according to the state of each electric control switch; and

sending the switch control signal to each electric control switch.

Optionally, in the above method of controlling the emergency power supply capable of outputting multiple voltages, before the step in response to the voltage switching signal, determining the series/parallel connection relations between different power supply assemblies according to the voltage switching signal, and determining the state of each electric control switch according to the series/parallel connection relations, the method further comprises:

acquiring a temperature signal, and determining the temperature of the emergency power supply according to the temperature signal; and

outputting a temperature regulating signal to the temperature regulating plate if the temperature of the emergency power supply is lower than the lower limit threshold or higher than the upper limit threshold.

Optionally, in an exemplary embodiment of a method of controlling the emergency power supply capable of outputting multiple voltages, before the step in response to the voltage switching signal, determining the series/parallel connection relations between different power supply assemblies according to the voltage switching signal, and determining the state of each electric control switch according to the series/parallel connection relations, the method further comprises:

acquiring a voltage signal representing a voltage value of a device to be connected, and using the voltage signal as the voltage switching signal if the voltage signal is within a normal voltage value range.

Optionally, in an exemplary embodiment of a method of controlling the emergency power supply capable of outputting multiple voltages, in the step of acquiring the voltage signal representing the voltage value of the device to be connected, and using the voltage signal as the voltage switching signal if the voltage signal is within the normal voltage value range comprises:

if the voltage signal indicates that the voltage value of the device to be connected is higher than a set threshold voltage, determining that the voltage switching signal corresponds to a high voltage value; otherwise, determining that the voltage switching signal corresponds to a low voltage value.

Optionally, in an exemplary embodiment of a method of controlling the emergency power supply capable of outputting multiple voltages, the step of acquiring the voltage signal representing the voltage value of the device to be connected, and using the voltage signal as the voltage switching signal if the voltage signal is within the normal voltage value range further comprises:

if the voltage signal is not within the normal voltage value range, determining that the voltage value of the device to be connected is abnormal, and sending a switching-off signal to each electric control switch.

Compared with the prior art, the foregoing technical solutions provided by the embodiments of the present invention at least have the following advantageous effects:

according to the emergency power supply capable of outputting multiple voltages and the control method thereof provided by the exemplary embodiments, the series/parallel connection relations of different power supply assemblies are controlled by arranging more than two power supply assemblies and utilizing the switching on or off of the electric control switch, so that the output of the emergency power supply can output different voltage values. A user can output different voltage values by using one emergency power supply only, thus meeting the use conditions of various vehicles at a low cost.

### BRIEF DESCRIPTION OF THE DRAWINGS

These and other features of the general inventive concept will become better understood with regard to the following description and accompanying drawings in which:

FIG. 1 is a schematic circuit diagram of an emergency power supply capable of outputting multiple voltages according to an exemplary embodiment;

FIG. 2 is a schematic circuit diagram of an emergency power supply capable of outputting multiple voltages according to another exemplary embodiment;

FIG. 3 is a schematic circuit diagram of an emergency power supply capable of outputting multiple voltages according to still another exemplary embodiment;

FIG. 4 is a schematic diagram of a temperature regulating structure of the power supply assembly according to an exemplary embodiment;

FIG. 5 is a flow chart of a control method of the emergency power supply capable of outputting multiple voltages according to an exemplary embodiment; and

FIG. 6 is a flow chart of a control method of the emergency power supply capable of outputting multiple voltages according to another exemplary embodiment.

### DETAILED DESCRIPTION

In the following exemplary embodiments, the terms “first”, “second” and “third” are used for descriptive purposes only and cannot be understood as indicating or implying relative importance. The terms “first position” and “second position” are two different positions. The technical solutions in the following embodiments provided by the invention can be combined with each other unless the technical solutions are contradicted with each other, and the technical features therein can be replaced with each other.

In the description of the exemplary embodiments, it should be understood that if the orientation or positional relationship indicated by the terms “middle”, “upper”, “lower”, “left”, “right”, “vertical”, “horizontal”, “inner”, “outer” and the like is based on the orientation or positional relationship shown in the drawings, it is only for the convenience of describing the invention and simplifying the description, and it is not to indicate or imply that the indicated device or element must have a specific orientation, be constructed and operate in a specific orientation. Therefore, the terms should not be construed as limiting the invention. Moreover, the terms “first”, “second” and “third” are used for descriptive purposes only and cannot be understood as indicating or implying relative importance. The terms “first position” and “second position” are two different positions.

In the description of the invention, it should be noted that the terms “installation”, “connected” and “connection” should be understood in a broad sense unless otherwise specified and defined. For example, they can be fixed connection, removable connection or integrated connection, can be mechanical connection or electrical connection, can be directly connected, can also be indirectly connected through an intermediate medium, and can be connected inside two components. The specific meaning of the above terms in the invention can be understood in a specific case by those skilled in the art.

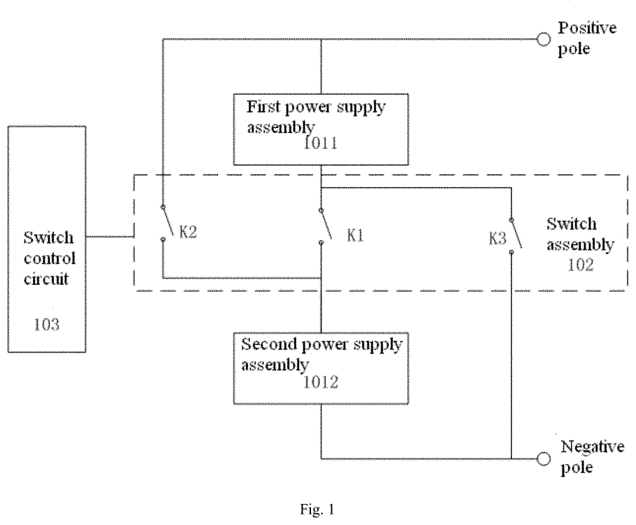

An exemplary embodiment provides an emergency power supply capable of outputting multiple voltages. In this embodiment, two power supply assemblies (1011 and 1112) shown in FIG. 1 are taken as an example for description. As shown in FIG. 1, the emergency power supply comprises two power supply assemblies (which are respectively a first power supply assembly 1011 and a second power supply assembly 1012), a switch assembly 102, and a switch control circuit 103. Each power supply assembly 1011 and 1012 is used for outputting a specific voltage value, and two ends of each power supply assembly 1011 and 1012 are respectively electrically connected with an output end of the emergency power supply directly or indirectly. The switch assembly 102 comprises at least an electric control switch; and the electric control switch is connected in series between one power supply assembly 1011 and 1012 and the output end of the emergency power supply, and/or between different power supply assemblies 1011 and 1012. In this exemplary embodiment, the electric control switch assembly comprising three electric control switches is taken as an example for description, i.e., a first electric control switch K1, a second electric control switch K2 and a third electric control switch K3.

In FIG. 1, a first end of the first power supply assembly 1011 is electrically connected with a first end (positive pole) of the emergency power supply, and a second end of the first power supply assembly 1011 is connected with a first end of the first electric control switch K1. A second end of the first electric control switch K1 is electrically connected with a first end of the second power supply assembly 1012, and a second end of the second power supply assembly 1012 is connected with a second end (negative pole) of the emergency power supply. A first end of the second electric control switch K2 is connected with the first end of the first power supply assembly 1011, and a second end of the second electric control switch K2 is connected with the second end of the first electric control switch. A first end of the third electric control switch K3 is connected with the second end of the first power supply assembly 1011, and a second end of the third electric control switch K3 is connected with a second end of the second power supply assembly 1012. When in use, the anode and cathode ends of the emergency power supply can be respectively connected with the positive and negative poles of a vehicle battery.

In an exemplary embodiment, an input of the switch control circuit 103 receives a voltage switching signal; an output of the switch control circuit 103 outputs a switch control signal corresponding to the voltage switching signal to a controlled end of each electric control switch; and each electric control switch is switched on or off under control of the switch control signal, so that different power supply assemblies 1011 and 1012 are connected in series or in parallel, and thus different voltage values are outputted by the output end of the emergency power supply. As shown in FIG. 1, on or off state of different electric control switches can realize the conversion of the series and parallel relations between different power supply assemblies 1011 and 1012. Referring to FIG. 1, when the first electric control switch K1 is in an off state and the second electric control switch K2 and the third electric control switch K3 are in an on state, the two power supply assemblies (1011 and 1012) are connected in parallel, and the voltage output by the emergency power supply is the voltage equivalent to either of the power supply assemblies. When the first electric control switch K1 is in an on state and the second electric control switch K2 and the third electric control switch K3 are in an off state, the two power supply assemblies are connected in series, and the voltage value output by the emergency power supply is the sum of the voltage values of the two power supply assemblies (1011 and 1012).

The switch control circuit 103 may be a micro controller unit (MCU) chip, and the number of ports of the MCU chip is determined according to the number of components to be controlled. Taking the circuit diagram of FIG. 1 as an example, the MCU chip may have three output ports, each of which can be connected with the controlled end of one electric control switch. The MCU chip may have an input which may be provided with a dial switch, where the position of the dial switch can be regulated and controlled to determine which voltage value the emergency power supply should output. Those of ordinary skill in the art would understand that a data table could be stored in the MCU chip. The number of external power supply assemblies and connection positions of the electric control switches have been determined, so the state of each electric control switch corresponds to the series/parallel relations between the power supply assemblies, and the series/parallel relations between the power supply assemblies correspond to a voltage value selected by the dial switch; therefore, only two sets of data are needed to be recorded in the data table: the voltage value selected by dial switch and the state of each electric control switch. In an exemplary embodiment, the output of the MCU chip can output an electric signal matching with a type of the electric control switch; for example, the controlled end of the electric control switch needs to receive a high level to be switched on, thus, a high level is outputted to the electric control switch that needs to be switched on, and a low level is outputted to the electric control switch that needs to be switched off.

Thus, the switch control circuit 103 in the above disclosed exemplary embodiment can be realized by using a commercially available MCU chip as long as the MCU chip is comfortable of storing data tables and searching data tables. When the input receives signals to determine which voltage values to output, it can be determined which electric signals need to be outputted to each electric control switch by referring to a data table for comparison. Therefore, this process can be realized by using commercially available components.

In addition, for the emergency power supply proposed in the above-mentioned exemplary embodiment, in addition to the exemplary circuits shown in the Figs., an exemplary embodiment of the emergency power supply may be equipped with a housing, and a smart clip connecting wire can be connected to the positive pole and the negative pole shown in FIG. 1 through a shell of the housing. The dial switch mentioned in the above exemplary embodiment may be disposed on an outer surface of the housing. The housing can also be provided with components such as a master switch of the emergency power supply, a state indicator lamp, and the like. Since the working principles of these components are known, they will not be described in detail, and those skilled in the art can implement them with reference to available literature.

In the emergency power supply capable of outputting multiple voltages and the control method thereof provided by exemplary embodiments, the series and parallel relations of different power supply assemblies are controlled by arranging more than two power supply assemblies and utilizing the switching on or off of electric control switches, so that the emergency power supply can output different voltage values. Thus, such embodiments permit users to output different voltage values using one emergency power supply, thus meeting the requirements of various vehicles at the lowest cost.

In the above solution, the power supply assemblies (1011 and 1012) can be implemented in the form of a power source such as a battery, preferably a rechargeable battery. In an exemplary embodiment, a plurality of lithium iron phosphate batteries connected in series are adopted to realize the required characteristics of each power supply assembly (1011 and 1012). The voltage of each lithium iron phosphate battery can be set according to the requirement of the emergency power supply. In the following examples, an exemplary embodiment will be described in detail with an emergency power supply capable of providing 6V and 12V voltage values. In another example, an emergency power supply capable of providing 12V and 24V will be described.

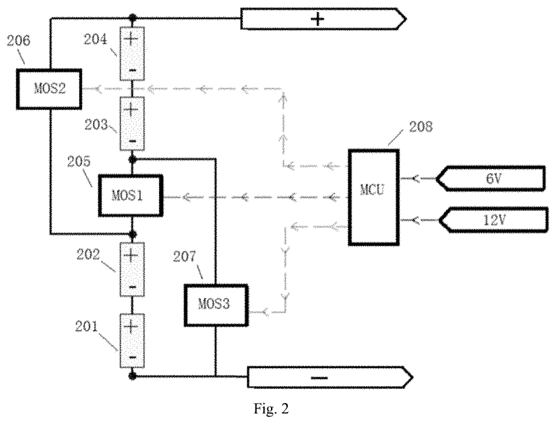

In order to meet the requirement of outputting a 6V or 12V voltage value and the requirement that the built-in battery in the vehicle can be used for the above two voltage values, both of the first power supply assembly 1011 and the second power supply assembly 1012 in this exemplary embodiment consists of two 3.2V lithium iron phosphate batteries connected in series. Further, the first electric control switch K1, the second electric control switch K2 and the third electric control switch K3 are all MOS transistors with a withstand voltage of 30V or more and an on-state current of 290 A or more, thereby being capable of satisfying a transient heavy current, wherein a gate of the MOS transistor is taken as the controlled end, and a source and a drain of the MOS transistor are taken as the first end and the second end. Referring to FIG. 2, wherein a first battery 201, a second battery 202, a third battery 203 and a fourth battery 204 are all 3.2V lithium iron phosphate batteries. The first battery 201 and the second battery 202 form a second power supply assembly (which can provide a 6.4V voltage value), while the third battery 203 and the fourth battery 204 form a first power supply assembly (which can provide a 6.4V voltage value). A MOS1 switch 205, a MOS2 switch 206, and a MOS3 switch 207 serve as electric control switches. An MCU chip 208 is a core device in the switch control circuit. The MCU chip 208 can use two inputs to receive voltage switching signals representing 6V mode and 12V modes respectively. A first output of the MCU chip 208 is electrically connected with a gate of the MOS1 switch 205, a second output of the MCU chip 208 is electrically connected with a gate of the MOS2 switch 206, and a third output of the MCU chip 208 is electrically connected with a gate of the MOS3 switch 207. The connection of the source and the drain of each MOS transistor is determined according to the voltages at both ends of the type (N channel or P channel) of the MOS transistor to enable the MOS transistor to realize working conditions for switching on and switching off.

Referring to FIG. 2, when an input of the MCU chip 208 receives the voltage switching signal representing a 6V mode, a switch control signal is outputted to switch off the MOS1 switch 205 and switch on the MOS2 switch 206 and the MOS3 switch 207. The voltage value outputted by the output of the emergency power supply is thus a voltage value produced by the first power supply assembly 1011 and the second power supply assembly 1012 connected in parallel, i.e., a 6.4V voltage value is output. When the input of the MCU chip 208 receives the voltage switching signal representing a 12V mode, a switch control signal is outputted to switch on the MOS1 switch 205 and switch off the MOS2 switch 206 and the MOS3 switch 207. The voltage value outputted by the output of the emergency power supply is a voltage value produced by the first power supply assembly 1011 and the second power supply assembly 1012 connected in series, i.e., a 12.8V voltage value is output.

As previously mentioned, the positive pole and the negative pole of the emergency power supply can be connected to a positive pole and a negative pole of a battery of a vehicle through a smart clip connecting wire, so that an engine of the vehicle can be started. In this way, one emergency power supply can output either 6V or 12V voltages, thus enabling the emergency power supply to have the function of igniting and starting 6V and 12V devices.

In order to meet the requirement of outputting a 12V or 24V voltage value and the requirement that the built-in battery in the vehicle can require one of the above two voltage values, both of the first power supply assembly 1011 and the second power supply assembly 1012 in this exemplary embodiment consist of three 4.2V lithium iron phosphate batteries connected in series. Further, the first electric control switch K1, the second electric control switch K2, and the third electric control switch K3 are all MOS transistors with a withstand voltage of 30V or more and an on-state current of 290 A or more, thereby being capable of satisfying a transient heavy current requirement, wherein a gate of the MOS transistor is taken as the controlled end, and a source and a drain of the MOS transistor are taken as the first end and the second end.

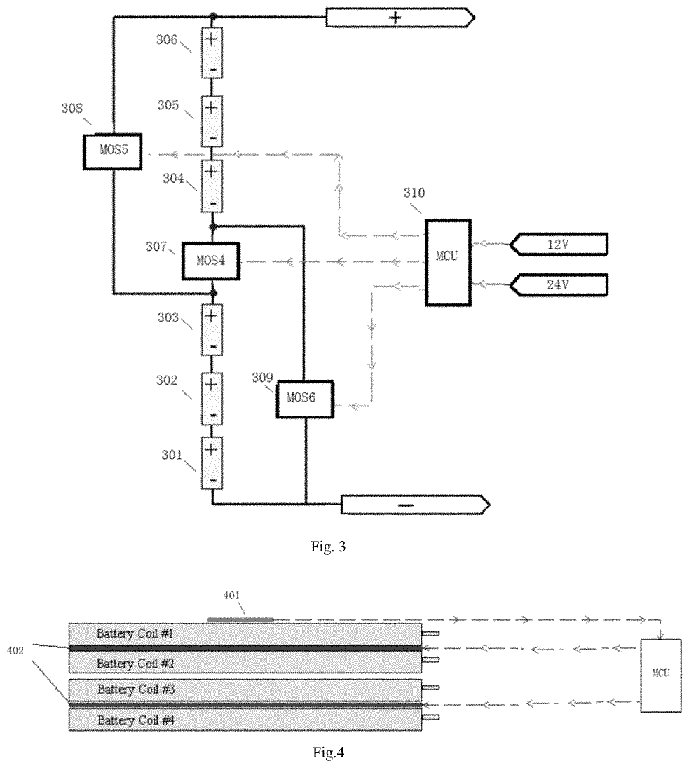

Referring to FIG. 3, wherein a first battery 301, a second battery 302, a third battery 303, a fourth battery 304, a fifth battery 305 and a sixth battery 306 are all 4.2V lithium iron phosphate batteries. The first battery 301, the second battery 302 and the third battery 303 form a second power supply assembly (which can provide a 12.6V voltage value), while the fourth battery 304, the fifth battery 305 and the sixth battery 306 form a first power supply assembly (which can provide a 12.6V voltage value). A MOS4 switch 307, a MOS5 switch 308, and a MOS6 switch 309 serve as three electric control switches. A MCU chip 310 is a core device in the switch control circuit. The MCU chip 310 can use two inputs to receive voltage switching signals representing 12V mode and 24V mode respectively. A first output of the MCU chip 310 is electrically connected with a gate of the MOS4 switch 307, a second output of the MCU chip 310 is electrically connected with a gate of the MOS5 switch 308, and a third output of the MCU chip 310 is electrically connected with a gate of the MOS6 switch 309. The connection of the source and the drain of each MOS transistor is determined according to the voltages at both ends of the type (N channel or P channel) of the MOS transistor to enable the MOS transistor to realize working conditions for switching on and switching off.

Referring to FIG. 3, when the input of the MCU chip 310 receives the voltage switching signal representing a 12V mode, a switch control signal is outputted to switch off the MOS4 switch 307 and switch on the MOS5 switch 308 and the MOS6 switch 309. The voltage value outputted by the output of the emergency power supply is a voltage value produced by the first power supply component and the second power supply component connected in parallel, i.e., a 12.6V voltage value is output. When the input end of the MCU chip 310 receives the voltage switching signal representing a 24V mode, a switch control signal is outputted to switch on the MOS4 switch 307 and switch off the MOS5 switch 308 and the MOS6 switch 309. The voltage value outputted by the output end of the emergency power supply is a voltage value produced by the first power supply component (a combination of the first battery 301, the second battery 302, and the third battery 303) and the second power supply component (a combination of a fourth battery 304, a fifth battery 305, and a sixth battery 306) connected in series, i.e., a 25.2 V voltage value is output.

As previously mentioned, the positive pole and the negative pole of the emergency power supply can be connected to a positive pole and a negative pole of a battery of a vehicle through a smart clip connecting wire, so that an engine of the vehicle can be started. In this way, one emergency power supply can be configured to output 12V and 24V voltages, thus enabling the emergency power supply to have the function of igniting and starting 12V and 24V devices. In such a manner, the needs of ordinary household cars (12V) and engineering vehicles and trucks (24V) can be satisfied.

In the above exemplary embodiment, the way in which the switch control circuit 103 receives the voltage switching signal can be realized either manually (with a dial switch, as described above) or automatically. Preferably, an exemplary embodiment of an emergency power supply capable of outputting multiple voltages may also comprise a voltage sensor, wherein the voltage sensor is used for detecting a voltage value of a device to be connected and outputting a voltage signal representing the voltage value of the device to be connected; if the voltage signal is within a normal voltage value range, the voltage signal is used as the voltage switching signal.

In an exemplary embodiment, the voltage sensor may have two inputs, and the two inputs may be electrically connected with the positive pole and the negative pole of the emergency power supply directly and correspondingly. When the positive pole and the negative pole of the emergency power supply are connected to two poles of the built-in battery of the vehicle, which is equivalent to a fact that the two ends of the voltage sensor being connected to the built-in battery, the voltage sensor can detect a voltage value of the built-in battery. If the voltage value of the built-in battery is within the normal voltage value range, the voltage value can be directly used as the voltage switching signal. For example, when the voltage sensor detects that the voltage value of the built-in battery is between 14V and 26V, it can be presumed that the built-in battery is used for 24V ignition, and then the emergency power supply can be controlled to output a 24V voltage value. When the voltage sensor detects that the voltage value of the built-in battery is less than 14V, it can be presumed that the built-in battery is used for 12V ignition, and then the emergency power supply can be controlled to output a 12V voltage value.

In this solution, the emergency power supply can be automatically controlled to output a corresponding voltage value by automatically identifying the voltage of the built-in battery connected with the emergency power supply, thus avoiding manual control of the emergency power supply. This solution can reduce the operational difficulty, can avoid a charge impact caused by manual switch operation, and can also avoid the situation of human operation errors.

An emergency power supply capable of outputting multiple voltages provided by the exemplary embodiment, as shown in FIG. 4, further comprises a temperature sensor 401 and a temperature regulating plate 402, wherein the temperature sensor is used for detecting a temperature of the emergency power supply and outputting a temperature signal representing the temperature of the emergency power supply to the switch control circuit. After the temperature signal is received by the switch control circuit, if the temperature signal indicates that the temperature of the emergency power supply is lower than a lower limit threshold or higher than an upper limit threshold, a temperature regulating signal is outputted by the output of the switch control circuit. The temperature regulating plate is arranged in the power supply assembly, and the temperature regulating signal is received by a controlled end of the temperature regulating plate to raise or lower the temperature of the power supply assembly.

The temperature sensor can be disposed in a housing, and when the temperature of the emergency power supply is detected, it is equivalent to the temperature of the power supply assembly. In general, if the signal detected by the temperature sensor is an analog signal, the signal is converted into a digital signal by an analog-to-digital conversion module before the signal enters the MCU chip.

In general, a battery has a working temperature range and a storage temperature range. Once the battery temperature falls outside of the working temperature range, the battery cannot work normally or effectively. Therefore, in this exemplary embodiment, the temperature sensor is arranged to detect the temperature of the emergency power supply to judge whether the emergency power supply can work normally. If the temperature of the emergency power supply is such that it cannot work normally, the temperature of the power supply assembly is regulated by the temperature regulating plate to cause the emergency power supply to rapidly adjust its temperature to within its working temperature range. Preferably, an indicator lamp can also be arranged on the housing, and a driving circuit of the indicator lamp can be connected with the switch control circuit. Thus, when the battery assembly needs to be heated, the indicator lamp is driven to emit light. The indicator lamp can emit red light to remind the user to wait for a period of time to permit the battery to reach the correct temperature range prior to operation. In the above exemplary embodiment, a negative temperature coefficient (NTC) temperature sensor is used as the temperature sensor.

When the power supply assembly is configured by connecting a plurality of batteries in series, as shown in FIG. 4, the temperature regulating plate 402 can be arranged between two adjacent batteries. In the above solution, the temperature sensor 401 detects the temperature of the emergency power supply in real time, so that the temperature signal can be transmitted to the MCU chip in real time. Once the MCU chip determines that the current temperature signal indicates that the battery assembly can work normally, a signal to stop the temperature regulation can be sent, and the temperature regulating plate 402 stops working. At this time, the indicator lamp can turn off or turn to green.

In the above technical solution provided by the exemplary embodiment, with respect to problem that the emergency power supply cannot be started normally in cold weather, the working principles of automatic temperature detection and automatic heating sensing are specially designed, and the MCU chip is used to control the working temperature to heat the power supply components to the normal working temperature, so that the emergency power supply can be used to start a vehicle in cold weather. In addition, under extremely hot conditions, exemplary embodiments replace the heating operation with a cooling operation. The control concepts are sufficiently similar such that one of ordinary skill in the art could configure the cooling operation based on the information provided herein, thus, the cooling operation will not be described in detail.

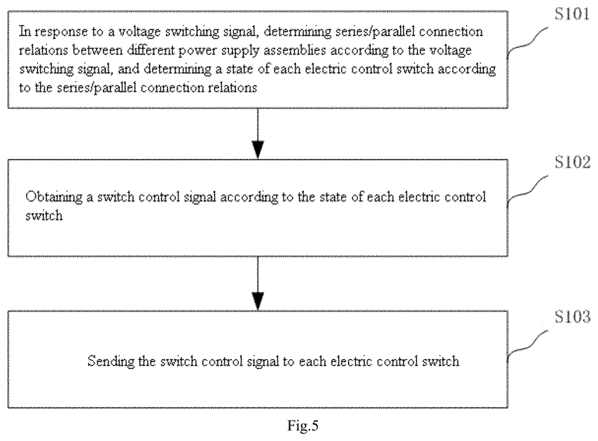

Another exemplary embodiment provides a method of controlling an emergency power supply capable of outputting multiple voltages. In such a control method, the emergency power supply capable of outputting multiple voltages may adopt any solution described earlier herein with regard to control of the series/parallel configuration of the power supply assembly, voltage detection, and temperature regulation of the various embodiments discussed, and the method can be applied to the MCU chip, as shown in FIG. 5, comprising the following steps of:

S101: in response to a voltage switching signal, determining series/parallel connection configuration of the different power supply assemblies according to the voltage switching signal, and determining a state of each electric control switch according to the series/parallel connection configurations;

S102: obtaining a switch control signal according to the state of each electric control switch; and

S103: sending the switch control signal to each electric control switch.

A data table can be set, in which a corresponding relation between the voltage value and the state of each electric control switch is recorded. The number of external power supply assemblies and a connection position of the electric control switch are determined, the state of each electric control switch corresponds to the series/parallel relations between the power supply assemblies, and the series/parallel relations between the power supply assemblies correspond to a voltage value, so the output of the MCU chip can output an electric signal matching with a type of the electric control switch. For example, the controlled end of the electric control switch needs to receive a high level to be switched on, so a high level is outputted to the electric control switch needing to be switched on, and a low level is outputted to the electric control switch that needs to be switched off. When the input of the MCU chip receives signals to determine which voltage values to output, it can be determined which electric signals need to be outputted to each electric control switch after simple table lookup for comparison.

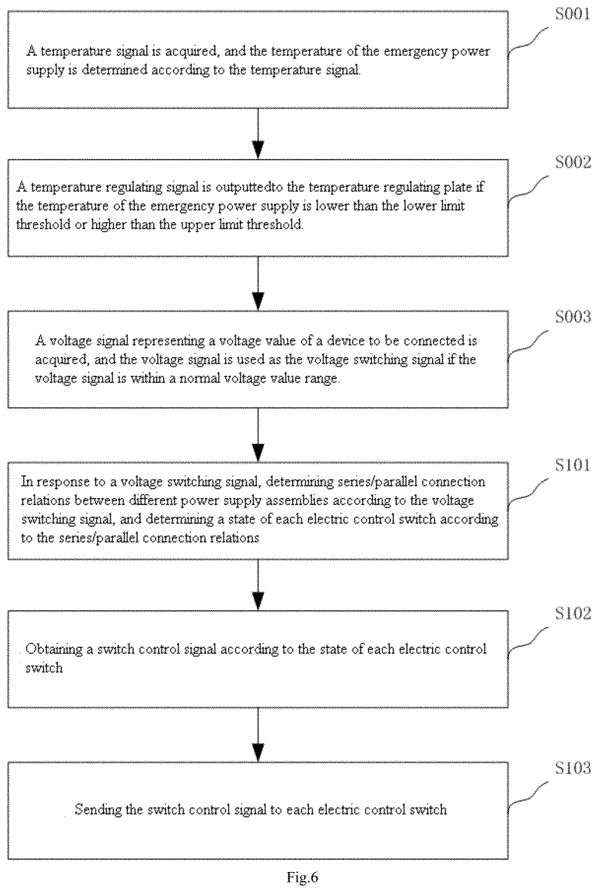

Preferably, as shown in FIG. 6, before the above step S101, the method may further comprise the following steps.

In S001, a temperature signal is acquired, and the temperature of the emergency power supply is determined according to the temperature signal. The temperature signal can be obtained by the temperature sensor disposed in the emergency power supply as described earlier herein.

In S002, a temperature regulating signal is outputted to the temperature regulating plate if the temperature of the emergency power supply is lower than the lower limit threshold or higher than the upper limit threshold. For example, the lower limit threshold can be 10° C., and the upper limit threshold can be 60° C. Other upper and lower thresholds may be used depending upon factors such as the type of batteries used.

Therefore, in exemplary embodiments, the temperature sensor is arranged to detect the temperature of the emergency power supply to judge whether the emergency power supply can operate normally. If the emergency power supply cannot operate normally, the temperature of the power supply assembly is regulated by the temperature regulating plate to make the emergency power supply quickly enter a temperature range of normal operation. Preferably, an indicator lamp can also be employed wherein the indicator lamp is arranged on the housing, and a driving circuit of the indicator lamp is in communication with the switch control circuit; when the battery assembly needs to be heated, the indicator lamp is driven to emit light. In an exemplary embodiment, the indicator lamp may emit red light to remind the user to wait for a period of time before operating the emergency power supply. In the above solution, an NTC sensor is used as the temperature sensor.

When the power supply assembly is configured by connecting a plurality of batteries in series, the temperature regulating plate can be arranged between two adjacent batteries. In the above solution, the temperature sensor 401 detects the temperature of the emergency power supply in real time, so that the temperature signal can be transmitted to the MCU chip in real time. Once the MCU chip determines that the current temperature signal indicates that the battery assembly can operate normally, a signal to stop the temperature regulation can be sent, and the temperature regulating plate 402 stops attempting to regulate the battery assembly temperature. At this time, the indicator lamp can be turned off or adjusted to display a green color.

In the above technical solution provided by the exemplary embodiment, with respect to the key problem that the emergency power supply cannot be started normally in cold weather, the working principles of automatic temperature detection and automatic heating sensing are specially designed, and the MCU chip is used to control the working temperature to heat the power supply component to the normal working temperature, so that the emergency power supply can applied to start a vehicle. In addition, as was describe earlier herein, under extremely hot conditions, the heating operation can be replaced with a cooling operation.

In S003, a voltage signal representing a voltage value of a device to be connected is acquired, and the voltage signal is used as the voltage switching signal if the voltage signal is within a normal voltage value range. The voltage signal can be obtained through a voltage sensor in this step. For example, when the voltage sensor detects that the voltage value of the built-in battery is between 14V and 26V, it can be considered that the built-in battery of the car, truck, or other device is used for a 24V ignition system, and then the emergency power supply can be controlled to output a 24V voltage value. When the voltage sensor detects that the voltage value of the built-in battery of the car, truck, or other device is less than 14V, it can be considered that the built-in battery is used for a 12V ignition system, and the emergency power supply can be controlled to output a 12V voltage value.

Moreover, if the voltage signal is not within the normal voltage value range, it is determined that the voltage value of the device to be connected is abnormal, and a switching-off signal is sent to each electric control switch. For example, if it is detected that the voltage value of the built-in battery exceeds 26V, a warning message of high battery voltage will be issued, and meanwhile, all the electric control switches will be turned off to protect the emergency power supply and the built-in battery. Based on a similar principle, if the voltage sensor can also be configured to detect the voltage value of the power supply assembly, and if the voltage value of the power supply assembly is found to be lower than 9V, a signal indicating that the power supply assembly would not function correctly and needs to be charged.

In this exemplary embodiment, the emergency power supply can be automatically controlled to output a corresponding voltage value by automatically identifying the voltage of the built-in battery connected with the emergency power supply, thus avoiding manual control of the emergency power supply. This solution can reduce the operation difficulty, can avoid a charge impact caused by manual switch operation, and can also avoid the situation of human operation errors.

It should be finally noted that the above exemplary embodiments are only used to illustrate the technical solution of the invention, rather than limiting the invention; although the invention has been described in detail with reference to the foregoing embodiments, those with ordinary skills in the art should understand that the technical solutions described in the foregoing embodiments can be still modified or some of the technical features can be equivalently replaced; however, these modifications or substitutions shall not depart from the spirit and scope of the technical solutions of the embodiments of the invention.

1. An emergency power supply capable of outputting multiple voltages, comprising two or more power supply assemblies, a switch assembly, and a switch control circuit, wherein:
each power supply assembly outputting a specific voltage value, and each end of each power supply assembly are respectively electrically connected with an output end of the emergency power supply directly or indirectly;
the switch assembly comprising at least one electric control switch; and the at least one electric control switch is connected in a location selected from one of: in series between one power supply assembly and the output end of the emergency power supply, or between different power supply assemblies; and
an input of the switch control circuit receiving a voltage switching signal; an output of the switch control circuit configured to output a switch control signal corresponding to the voltage switching signal to a controlled end of the at least one electric control switch; and the at least one electric control switch is switched on or off under control of the switch control signal, so that different power supply assemblies are connected in series or in parallel in order to output different voltage values from the output end of the emergency power supply.

2. The emergency power supply of claim 1, wherein the emergency power supply comprising a first power supply assembly and a second power supply assembly; and the switch assembly comprising a first electric control switch, a second electric control switch, and a third electric control switch; wherein:
a first end of the first power supply assembly is electrically connected with a first output end of the emergency power supply, and a second end of the first power supply assembly is connected with a first end of the first electric control switch;
a second end of the first electric control switch is connected with a first end of the second power supply assembly, and a second end of the second power supply assembly is connected with a second output end of the emergency power supply;
a first end of the second electric control switch is connected with the first end of the first power supply assembly, and a second end of the second electric control switch is connected with the second end of the first electric control switch; and
a first end of the third electric control switch is connected with the second end of the first power supply assembly, and a second end of the third electric control switch is connected with the second end of the second power supply assembly.

3. The emergency power supply of claim 2, wherein:
the first power supply assembly and the second power supply assembly each comprise a plurality of lithium iron phosphate batteries connected in series.

4. The emergency power supply of claim 3, wherein:
each of the first power supply assembly and the second power supply assembly consists of two lithium batteries connected in series; or, both of the first power supply assembly and the second power supply assembly consists of three lithium batteries connected in series.

5. The emergency power supply of claim 3, wherein:
each of the first power supply assembly and the second power supply assembly consists of three lithium batteries connected in series.

6. The emergency power supply of claim 2, wherein:
the first electric control switch, the second electric control switch, and the third electric control switch are MOS transistors, a gate of each of the MOS transistors is used as the controlled end, and a source and a drain of each of the MOS transistors are used as the first end and the second end.

7. The emergency power supply of claim 6, wherein the switch control circuit comprises a controller; and
an input of the controller receiving the voltage switching signal; a first output of the controller is electrically connected with the gate of the MOS transistor of the first electric control switch, a second output of the controller is electrically connected with the gate of the MOS transistor of the second electric control switch, and a third output of the controller is electrically connected with the gate of the MOS transistor of the third electric control switch.

8. The emergency power supply of claim 2, wherein:
when the voltage switching signal corresponds to a low voltage value, the controller outputs a switch control signal to switch off the first electric control switch and switch on the second electric control switch and the third electric control switch; and a voltage value outputted by the output end of the emergency power supply is a voltage value produced by the first power supply assembly and the second power supply assembly connected in parallel; and
when the voltage switching signal corresponds to a high voltage value, the controller outputs a switch control signal to switch on the first electric control switch but switch off the second electric control switch and the third electric control switch; and a voltage value outputted by the output end of the emergency power supply is a voltage value produced by the first power supply assembly and the second power supply assembly connected in series.

9. The emergency power supply of claim 6, further comprising a voltage sensor, wherein:
the voltage sensor detects a voltage value of a device to be connected and outputs a voltage signal representing the voltage value of the device to be connected, and if the voltage signal is within a normal voltage value range, the voltage signal is used as the voltage switching signal.

10. The emergency power supply of claim 1, further comprising a temperature sensor and a temperature regulating plate, wherein:
the temperature sensor detects a temperature of the emergency power supply and outputs a temperature signal representing the temperature of the emergency power supply to the switch control circuit;
after the temperature signal is received by the switch control circuit, if the temperature signal indicates that the temperature of the emergency power supply is lower than a lower limit threshold or higher than an upper limit threshold, a temperature regulating signal is outputted by the output of the switch control circuit; and
the temperature regulating plate is arranged in the power supply assembly, and the temperature regulating signal is received by a controlled end of the temperature regulating plate to raise or lower the temperature of the power supply assembly.

11. A method of controlling the emergency power supply capable of outputting multiple voltages of claim 1, comprising the following steps of:
in response to a voltage switching signal, determining series/parallel connection relations between different power supply assemblies according to the voltage switching signal, and determining a state of each electric control switch according to the series/parallel connection relations;
obtaining a switch control signal according to the state of each electric control switch; and
sending the switch control signal to each electric control switch.

12. The method of claim 11, wherein before the step of in response to the voltage switching signal, determining the series/parallel connection relations between different power supply assemblies according to the voltage switching signal, and determining the state of each electric control switch according to the series/parallel connection relations, the method further comprises:
acquiring a temperature signal, and determining the temperature of the emergency power supply according to the temperature signal; and
outputting a temperature regulating signal to the temperature regulating plate if the temperature of the emergency power supply is lower than the lower limit threshold or higher than the upper limit threshold.

13. The method of claim 12, wherein before the step of in response to the voltage switching signal, determining the series/parallel connection relations between different power supply assemblies according to the voltage switching signal, and determining the state of each electric control switch according to the series/parallel connection relations, the method further comprises:
acquiring a voltage signal representing a voltage value of a device to be connected, and using the voltage signal as the voltage switching signal if the voltage signal is within a normal voltage value range.

14. The method of claim 13, wherein in the step of acquiring the voltage signal representing the voltage value of the device to be connected, and using the voltage signal as the voltage switching signal if the voltage signal is within the normal voltage value range comprises:
if the voltage signal indicates that the voltage value of the device to be connected is higher than a set threshold voltage, determining that the voltage switching signal corresponds to a high voltage value;
otherwise, determining that the voltage switching signal corresponds to a low voltage value.

14. The method of claim 13, wherein the step of acquiring the voltage signal representing the voltage value of the device to be connected, and using the voltage signal as the voltage switching signal if the voltage signal is within the normal voltage value range further comprises:
if the voltage signal is not within the normal voltage value range, determining that the voltage value of the device to be connected is abnormal, and sending a switching-off signal to each electric control switch.

16. An emergency power supply capable of outputting multiple voltages, comprising a first power supply assembly and a second power supply assembly, a switch assembly comprising a first electric control switch, a second electric control switch, and a third electric control switch, and a switch control circuit, wherein:
each of the first power supply assembly and the second power supply assembly comprise a plurality of lithium iron phosphate batteries connected in series;
each power supply assembly outputting a specific voltage value, and each end of each power supply assembly are respectively electrically connected with an output end of the emergency power supply directly or indirectly;
a first end of the first power supply assembly is electrically connected with a first output end of the emergency power supply, and a second end of the first power supply assembly is connected with a first end of the first electric control switch;
a second end of the first electric control switch is connected with a first end of the second power supply assembly, and a second end of the second power supply assembly is connected with a second output end of the emergency power supply;
a first end of the second electric control switch is connected with the first end of the first power supply assembly, and a second end of the second electric control switch is connected with the second end of the first electric control switch;
a first end of the third electric control switch is connected with the second end of the first power supply assembly, and a second end of the third electric control switch is connected with the second end of the second power supply assembly;
an input of the switch control circuit being receiving a voltage switching signal; an output of the switch control circuit configured to output a switch control signal corresponding to the voltage switching signal to a control input of at least one electric control switch; and the electric control switch is switched on or off as the result of the switch control signal, so that the power supply assemblies are connected in series or in parallel in order to output different voltage values from the output end of the emergency power supply;
when the voltage switching signal corresponds to a low voltage value, the controller outputs a switch control signal to switch off the first electric control switch and switch on the second electric control switch and the third electric control switch; and a voltage value outputted by the output end of the emergency power supply is a voltage value produced by the first power supply assembly and the second power supply assembly connected in parallel; and
when the voltage switching signal corresponds to a high voltage value, the controller outputs a switch control signal to switch on the first electric control switch but switch off the second electric control switch and the third electric control switch; and a voltage value outputted by the output end of the emergency power supply is a voltage value produced by the first power supply assembly and the second power supply assembly connected in series.
